(19) United States
(12) Patent Application Publication
(10) Pub. No.: US 2005/0016054 A1
(43) Pub. Date: Jan. 27, 2005

(54) Live bait rig

(76) Inventor: Raymond Plasky, Plover, WI (US)

Correspondence Address: DEWITT ROSS & STEVENS S.C., 8000 EXCELSIOR DR, SUITE 401, MADISON, WI, 53717-1914, US

(21) Appl. No.: 10/419,403

(22) Filed: Apr. 21, 2003

(51) Int. Cl. A01K 83/06

(52) U.S. Cl. 43/44.2

(57) ABSTRACT

A fishing rig for live bait is disclosed. The rig comprises a leader to which is attached a hook and a hook line. The hook line is configured so as to comprise an adjustable loop to which a second hook is attached. By adjusting the size of the loop the length of the hook line is also adjusted. The invention makes it possible to optimize the hook line for all sizes of bait fish. In addition, because the bait fish is attached directly to the strike hook, a sport fish taking the bait has a high probability of taking the hook as well. Other embodiments are disclosed which include a plurality of adjustable loops and hooks.

### FIELD OF THE INVENTION

The invention is directed to a rig for use in fishing and more specifically to a rig for use with live bait. The rig is designed so that the length of the hook lines can be adjusted such that different sizes of bait are optimally attached to the hooks of the rig.

### BACKGROUND OF THE INVENTION

A variety of lures and rigs have been described in the sport of fishing. While many lures resemble an animal or the preferred food of a fish, lures are inanimate objects made from a variety of organic and inorganic materials. Examples of lures range from those tied by hand and used in fly fishing to those made of plastic or rubber and resembling worms of various colors.

However, it is well known that many desirable sport fish prefer live bait. While lures have been designed to resemble or move like live bait fish, lures are inherently incapable of presenting all attributes of the living bait (such as smell). With these limitations in mind, other rigs have been developed to include live bait fish. Such rigs include, for example, the rig described in Hughs, U.S. Pat. No. 4,307,532. Hughs describes a rig having a loop designed to encircle the bait fish around the mid-section, while a hook is attached adjacent to the loop such that a fish striking the bait will take the hook too.

Another example is described in U.S. Pat. No. 4,229,901 to Flowers et al. Flowers et al. describe a device resembling a two-barbed hook with the exception that the second barb lacks a point. In place of a point, the second barb comprises an eyelet through which a line is threaded. The bait fish is then cradled within the second barb and the line is passed through the eyelet such that the fish is fastened securely into the cradle.

Yet another rig for live bait is illustrated in U.S. Patent Des. 271,232 to Cole. Cole illustrates a rig comprising a leader line having a hook on one end, below which is attached a short hook line. In this design, a bait fish is attached to the hook on the leader line, in close proximity to the hook on the hook line. In this fashion, when the target fish strikes the bait, the fish will also take the hook.

While the patents to Hughs, Flowers et al. and Cole attempt to solve the problem of attracting fish to live bait, their operation is less than ideal. For instance, the method used by Hughs relies solely on a girdle encircling the bait to retain it. Therefore, a good probability remains that the live bait fish will escape the grasp of the girdle. In addition, the hook relied on to catch the sport fish is not fixed within or suffciently close to the bait. This results in a higher probability that the sport fish will take the bait without taking the hook.

Similarly, the method relied on by Flowers et al. also relies on encircling the bait about the mid-section. In the case of the Flowers et al. rig, the bait fish is further immobilized by the cradle action of the hook. This arrangement results in limiting the bait fish's mobility, therefore obviating one of the goals in using live bait. Finally, the device illustrated by Cole holds the possibility that the bait fish may be taken without the hook or that the bait fish may escape before the sport fish has struck.

Because of the foregoing failings of the prior art, a device is needed for use with live bait wherein the bait fish is securely attached to a hook line, while the mobility of the bait fish is maintained and an appropriate hook is presented to the sport fish.

### SUMMARY OF THE INVENTION

It is therefore an object of the invention to provide a rig for use in fishing wherein a live bait fish is securely attached. It is a further object of the invention that the bait fish still maintains enough mobility to effect a swimming motion. It is a further object of the invention that the rig also provide adequate hook or hooks such that the sport fish striking the bait will take a hook. It is a further object of the invention that the rig be adjustable such that various size bait fishes can be attached to the rig without compromising the security of their attachment to the rig.

Therefore, in a preferred embodiment, the invention comprises a leader, the leader being adjustably attached to two or more hooks. In one version, the leader is attached at one end to the fishing line while at the other end is a connector. The connector has a hook attached directly to it, as well as a hook line. The hook line is designed such that the end distal to the connector comprises an adjustable loop wherein a second hook is attached.

This design allows a bait fish to be hooked to the rig at the most advantageous places. For instance, the bait fish may be hooked through the lip by the first hook and by the dorsal or tail fin by the second hook. Alternatively, the bait fish may be hooked by the dorsal fin and the tail fin if desired.

In another embodiment, the invention comprises a leader line and connector to which two hook lines are attached. In this embodiment, each hook line would have a hook allowing the bait fish to be attached thereto in the desired fashion. While both hook lines may be adjustable, in most embodiments, a single adjustable hook line will provide the adaptability necessary for different size bait.

In yet a further embodiment of the invention, the rig comprises a leader attached to a connector. The connector has a hook attached thereto as well as a first hook line. In this embodiment, the first hook line has an adjustable loop with a second hook attached thereto. The hook is further attached to a second hook line, the second hook line having a first and second end, both of which comprise adjustable loops. In this embodiment, the second hook line is connected to the second hook by means of the adjustable loop at a first end while the second end also comprises an adjustable loop to which is connected a third hook.

Further advantages of the invention will appear from a complete review of the Drawings and the Detailed Description, below.

### BRIEF DESCRIPTION OF THE DRAWINGS

FIG. 1 illustrates a rig of the invention having a single hook line.

FIG. 2 illustrates a rig of the invention having two hook lines.

FIG. 3 illustrates a rig of the invention comprising two hook lines linked in series.

### DETAILED DESCRIPTION OF THE INVENTION

The present invention is directed to a rig for use in fishing using live bait. The rig is designed such that the bait is securely attached to the rig, yet the mobility of the bait is not unduly impeded. Further, the rig is designed such that its length may be adjusted to accommodate various size bait fish. In addition, the rig is designed such that, in taking the bait, the sport fish will most likely take the hooks allowing it to be caught.

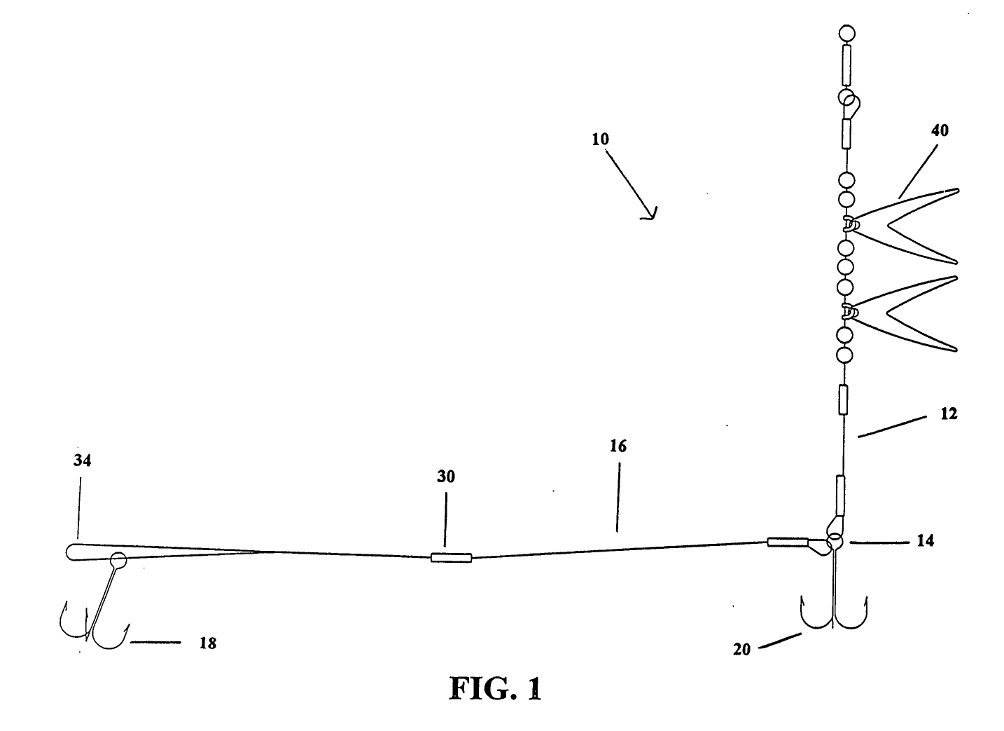

Referring now to FIG. 1, there is illustrated an embodiment of the present invention comprising a leader 12. The first end of the leader is attached to a fishing line (not shown), while the second end of the leader is attached to a connector 14. The connector has attached thereto a first hook 20 and also a hook line 16 having a first and second end. While the first end of the hook line is attached to the connector 14, the second end of the hook line comprises an adjustable loop 34. The adjustable loop is adjusted by means of a slidable sleeve 30 which movably attaches to the body of the hook line 16. By sliding the sleeve 30 along the body of the hook line 16, the loop 34 is made bigger or smaller. A smaller loop results in a longer line while a bigger loop results in a shorter line. By adjusting the loop 34, the distance between the first hook 20 and the second hook 18 is changed, thereby allowing a bait fish to be appropriately hooked so that the hooks are not tensioned and thereby allowing the bait to swim while remaining securely bound.

In addition, while the connector 14 may be any suitable connector, in some embodiments, the connector is a pin or quick connect device. In other embodiments, the connector may be a spiral ring as used in key-chains. In yet other embodiments, the connector may be the pin connector normally displaced at the end of the hook-line or leader-line.

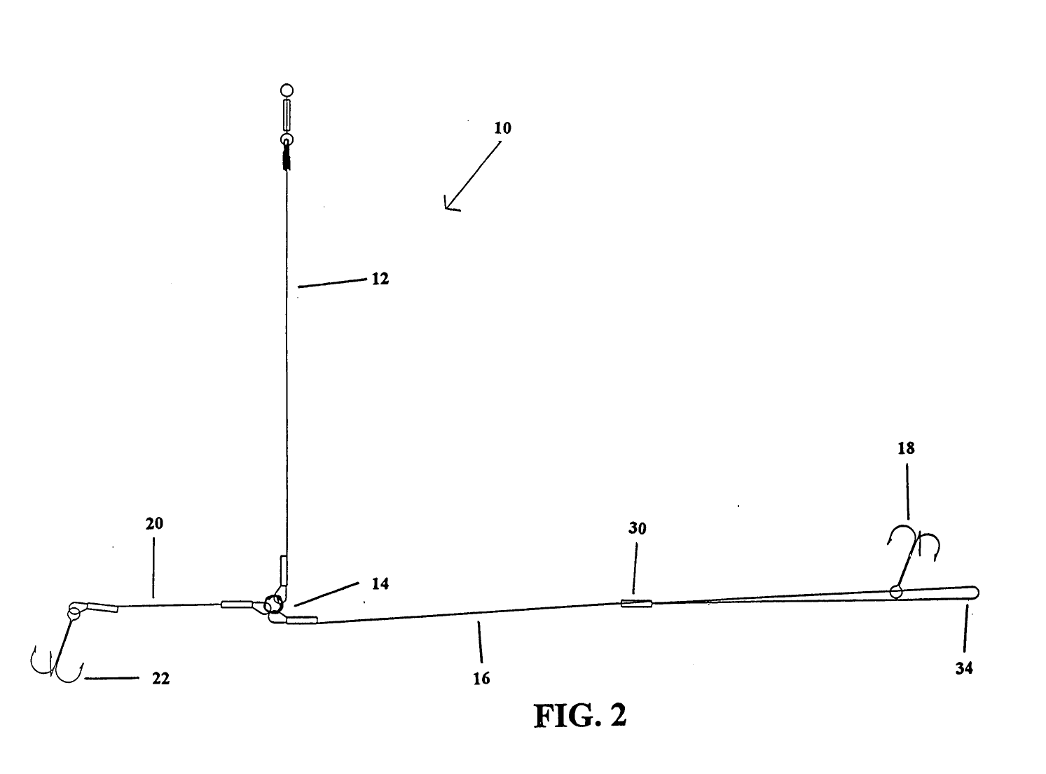

In another embodiment of the invention, the connector 14 has two hook lines attached thereto. See FIG. 2. In this embodiment, the first hook line 16 has an adjustable loop 34, having a slidable sleeve 30 as previously described. Further, displaced on the adjustable loop is a first hook 18. Also attached to the connector is a second hook line 20. In a preferred embodiment, the second hook line is not adjustable but merely comprises a first end attached to the connector and a second end which has a second hook 22 attached thereto. As previously described, the sliding sleeve 30 allows the adjustable loop 34 of the first hook line 18 to be made smaller or larger. Making the loop larger decreases the distance between the two hooks while decreasing the size of the loop lengthens the hook line, increasing the distance between the two hooks.

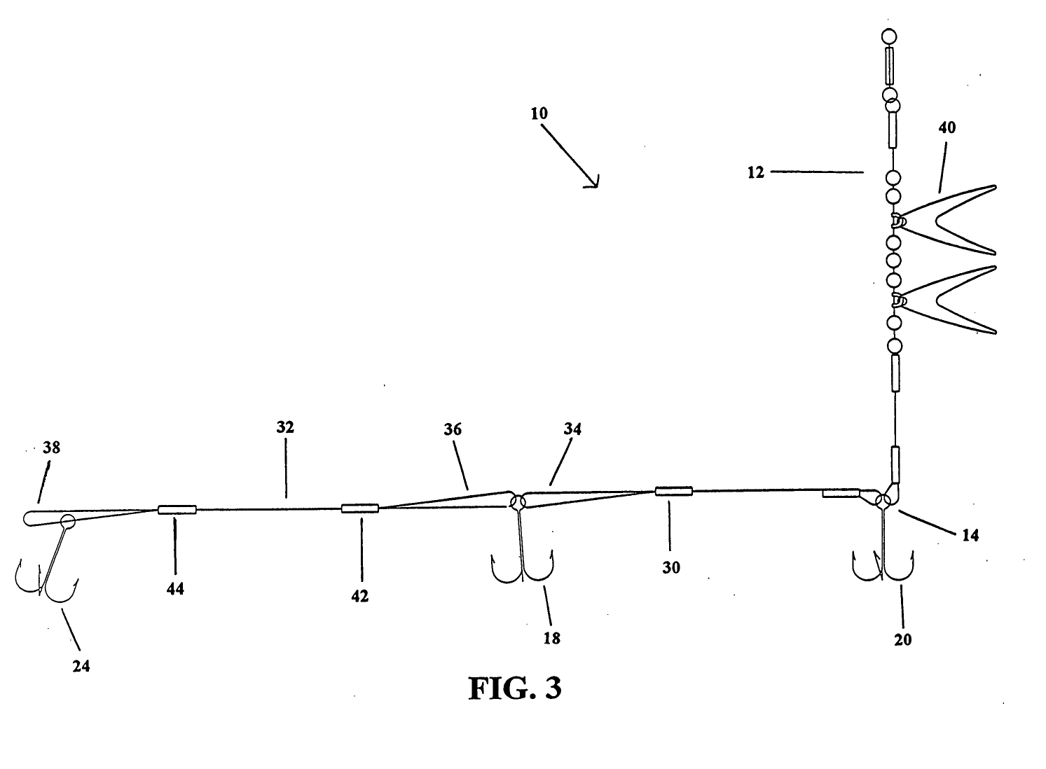

In yet another embodiment of the invention, the leader is provided having a connector 14 attached to the second end, and attached thereto is a first hook 20. See FIG. 3. The connector also has a hook line 16 attached thereto by a first end while the second end comprises an adjustable loop 34. A second hook 18 is attached to the adjustable loop 34, to which is also attached an adjustable loop 36 at the first end of a second hook line 32. The second hook line further has an adjustable loop 38 at the second end of the hook line 22, to which is attached a third hook 24. The first hook line has a slidable sleeve 30, which allows adjustment of the adjustable loop 34. The second hook line has a first slidable sleeve 42, allowing adjustment of the adjustable loop 36, and a second slidable sleeve 44, allowing adjustment of the second adjustable loop 38. In this manner, the embodiment described provides enough flexibility in length of line and plurality of hooks that most size bait may be accommodated.

It is a further feature of the invention that the leader and the hook lines may be supplied with a plurality of spinner blades 40 as desired by the fisherman. It is another feature of the invention that the hooks attached to the rig may be any hook deemed most suitable by the fisherman for the type of sport fish desired. In this respect the hooks may have one barb or many more depending on the desires of the fisherman. It is a further feature of the invention that the hooks do not have to be identical. Some hooks may be bigger or have more barbs than do other hooks.

It is understood that the invention is not confined to the particular construction and arrangement of parts herein illustrated and described but embraces such modified forms thereof as come within the scope of the following claims.

1. A rig for gripping live bait comprising:
a leader having a first end and a second end, wherein the first end is dimensioned and configured to be attached to a fishing line;
a connector connected to the second end of the leader;
a first hook connected to the connector;
a hook line, having a first end and a second end, the first end of the hook line connected to the connector and the second end of the hook line defining a loop; and
a second hook slidably fastened to the loop defined in the second end of the hook line.

2. The rig of claim 1, wherein the loop on the hook line is adjustable in size, thereby altering the length of the hook line.

3. The rig of claim 2, wherein the number of barbs on the first and second hooks is selected from the group consisting of one, two, three, four, and combinations thereof.

4. The rig of claim 1, further comprising a plurality of spinner blades deposited along the length of the leader.

5. A rig for gripping live bait comprising:
a leader having a first end and a second end, wherein the first end is dimensioned and configured to be attached to a fishing line;
a connector connected to the second end of the leader;
a first hook line having a first end and a second end, wherein the first end is connected to the connector and wherein the second end is connected to a first hook;
a second hook line, having a first end and a second end, the first end connected to the connector, the second end defining a loop; and
a second hook slidably fastened to the loop defined on the second end of the hook line.

6. The rig of claim 5, wherein the loop on the second hook line is adjustable in size, thereby altering the length of the second hook line.

7. The rig of claim 6, wherein the number of barbs on the first and second hooks is selected from the group consisting of one, two, three, four and combinations thereof.

8. The rig of claim 5, further comprising a plurality of spinner blades deposited along the length of the leader.

9. A rig for gripping live bait comprising:
a leader having a first end and a second end, wherein the first end is dimensioned and configured to be attached to a fishing line;
a connector connected to the second end of the leader;
a first hook connected to the connector;
a first hook line, having a first end and a second end, wherein the first end is connected to the connector and wherein the second end defines a first loop;
a second hook, slidably fastened to the first loop;
a second hook line, having a first end and a second end, the first end and the second end each defining a loop, wherein the second hook line is slidably fastened to the second hook by the loop defined at the first end of the second hook line; and
a third hook slidably fastened to the loop defined at the second end of the second hook line.

10. The rig of claim 9, wherein the loops in the first and second hook lines are adjustable in size, thereby altering the length of the hook lines.

11. The rig of claim 10, wherein the number of barbs on the first, second and third hooks is selected from the group consisting of one, two, three, four and combinations thereof.

12. The rig of claim 9, further comprising a plurality of spinner blades deposited along the length of the leader.
